(19) United States
(12) Patent Application Publication
(10) Pub. No.: US 2019/0251288 A1
(43) Pub. Date: Aug. 15, 2019

(54) ePHI-COMPLIANT GATEKEEPER SYSTEM AND METHODS

(71) Applicant: Virtual Viewbox, LLC, San Antonio, TX (US)

(72) Inventor: Douglas K. Smith, San Antonio, TX (US)

(21) Appl. No.: 16/393,636

(22) Filed: Apr. 24, 2019

Related U.S. Application Data
(63) Continuation of application No. 13/555,164, filed on Jul. 22, 2012.

(51) Int. Cl. G06F 21/62

(52) U.S. Cl. CPC G06F 21/6245

(57) ABSTRACT

An ePHI-compliant gatekeeper system that provides single, controlled access, editable in real-time, to an individual patient's medical information that remains remotely stored within internal network architecture from a variety of disparate healthcare professionals, medical systems, and vendors networks. The ePHI-compliant gatekeeper system is an independent, cloud-based architecture to ensure that inherent infrastructure does not compromise existing privacy requirements and the proprietary interests of partnered platformed networks. The ePHI-compliant gatekeeper system includes user equipment and a cloud-based vetting system. The cloud-based vetting system includes a Software as a Service (SaaS) module and a Platform as a Service (PaaS) module. The SaaS module provides user authentication at login. The PaaS module electronically provides real-time updated, single controlled access to individual patients medical information, accordingly, the cloud-based vetting system provides an infrastructure application that is a plugin component to a plurality of network entities that maintain such medical information.

### CROSS REFERENCE TO RELATED APPLICATIONS

This application is a continuation of U.S. patent application Ser. No. 13/555,164, filed Jul. 22, 2012, currently pending, the entire contents of which are incorporated by reference for all purposes.

### TECHNICAL FIELD

The present disclosure relates generally to communication systems and in particular to a system and method for governing, via an ePHI-compliant gatekeeper system, user access to at least one network from a plurality of networks that are platformed with the ePHI-compliant gatekeeper system, where the ePHI-compliant gatekeeper system ensures real-time user compliance with government regulations regarding electronic protected health information (hereinafter “ePHI”) for patients (such regulations as, among others, the Health Insurance Portability and Accountability Act (hereafter “HIPAA”) (Health Insurance Portability and Accountability Act of 1996 (HIPAA); Public L. 104-191, 101 Stat. 1936, enacted Aug. 21, 1996; The Health Information Technology for Economic and Clinical Health Act (HITECH Act) of the American Recovery and Reinvestment Act of 2009 (ARRA), Public L. 111-5, enacted Feb. 17, 2009, and the Security Standards for the Protection of Electronic Protected Health Information (the ePHI Security Rule) published Feb. 20, 2003 (45 C.F.R. Part 160 and Part 164, Subparts A and C)) and manages user access authorization(s) to patient-based medical information located within at least one network from the plurality of platformed networks.

### BACKGROUND

The Age of Healthcare Privacy and Security mostly began in 1996 as a response to the AIDS epidemic and concerns that an unauthorized release by healthcare entities of a patient's HIV status could have detrimental effects to a patient's subsequent insurability and employability. “The Health Insurance Portability and Accountability Act of 1996” (HIPAA) required the Secretary of the U.S. Department of Health and Human Services (HHS) to develop regulations for protecting the privacy and security of health information. To fulfill this requirement, the HHS provided what are commonly known as the HIPAA Privacy Rule and the HIPAA Security Rule.

Accordingly, the HIPAA Privacy Rule, via the Standards for Privacy of Individually Identifiable Health Information, established national governmental standards for the protection of health information. Generally, the Privacy Rule restricted use or disclosure of protected health information (“PHI”) of patients unless either satisfying the specific exceptions provided within the HIPAA Privacy Rule or by written authorization by the individual patient (or legal “personal representative”). The Privacy Rule, in part, permits either use or disclosure of protected health information for patient treatment, payment, or healthcare administration, such as insurance matters, as well as use or disclosure as part of a “limited data set” for academic research, public health or health care operations among others.

The Security Standards for the Protection of Electronic Protected Health Information (the HIPAA Security Rule) (45 CFR Part 160 and Part 164, Subparts A and C, published Feb. 20, 2003) established government regulations for protected health information, PHI, conveyed by electronic means (hence “ePHI”). The HIPAA Security Rule implements, at least in part, the protections contained in the Privacy Rule by addressing privacy safeguards including healthcare related network system privacy safeguards. Through a combination of voluntary compliance initiatives and implementing monetary fines, the Office for Civil Rights (OCR) was perceived by the healthcare industry to only marginally enforce the HIPAA Privacy and Security Rules.

As such, in response to a general perception by the healthcare industry that the voluntary compliance for the HIPAA regulations of the HIPAA Security and Privacy Rules, among other HIPAA regulations, lacked mandatory government enforcement, the government responded by enacting the Health Information Technology for Economic and Clinical Health Act (HITECH Act) as part of the American Recovery and Reinvestment Act of 2009 (ARRA). The HITECH Act expanded the privacy and security requirements to further encompass “covered entities” (i.e. all healthcare insurance providers that electronically transmit health information in connection with operations) as well as “business associates” of covered entities (i.e. entities that access electronic health information, ePHI, in the course of their business relationship with a covered entity). The HITECH Act provides penalties for “willful noncompliance”; reporting requirements for reporting an unauthorized release(s) of ePHI; and mandates stricter requirements for privacy and security than earlier HIPAA regulations.

Moreover, the HITECH Act imposes notification requirements for data breach(es) including unauthorized use(s) and disclosure(s) of unencrypted protected health information. Specifically, the HITECH Act requires that covered entities as well as business associates directly notify a patient of any unsecured breach of the patient's PHI. If, however, such a breach impacts five hundred or more patients or more, then the US Department of Health and Human Services must also be notified in addition to each patient. This notification will dubiously trigger a related posting of the breaching covered entity's or business associate's name on the HHS's public website, also well known in the industry as HHS's “Wall of Shame”. The HITECH Act also provides that local media outlets will also need to be notified to inform the public of a breach under certain conditions.

The HITECH Act requires that, upon request, a patient be provided access to their electronic protected health information, ePHI, and is further entitled to a listing of all individuals that have viewed that patient's ePHI. The HITECH Act mandates that only enough information regarding another's ePHI, i.e. the “minimum necessary”, be provided to any user (i.e. made “visible”) so as to only perform their occupational role within a healthcare system with respect to that patient's ePHI. Currently, under the HIPAA Privacy Rule, obtaining written permission or “consent” from individuals to use and disclose their protected health information for treatment, payment, and health care operations) is optional for all covered entities. It is presently at the discretion of each covered entity to create their own processes for obtaining consent, including consent form(s).

Additionally, the HITECH Act increasingly restricts use of a patient's ePHI for research purposes without written patient consent although researchers are still not restricted from using “de-identified” medical records in that personal identifying information is either removed or blocked from viewing by the researcher.

Further, the ARRA creates a financial incentive program for physicians and healthcare providers to adopt “meaningful use” of electronic medical records (EMR) but added increased standards for electronic transmission of medical records to qualify for financial incentives that include a requirement for patient portals to access and interact with their medical records. (See Phase 2 of the Meaningful Use (Proposed Final Ruling released March 2012, The Health Information Technology for Economic and Clinical Health Act (HITECH Act) § 134IO(d) (see eg. Meaningful Use (of Health Information Technology) Proposed Final Rule March/2012 (addressing the privacy and security concerns of ePHI)))).

Today, although federal regulatory mandates for network infrastructure interoperability between disparate medical entities remains very problematic, many medical entities are currently focusing on creating internal protocols in compliance with HIPAA and HITECH regulations among others. Health privacy and security experts remain quite reluctant to allow unrestricted access or data sharing with other medical entities and third parties due to security concerns and proprietary intranetwork investment interests. Moreover, under the present HITECH Act, a breach where electronic protected health information is compromised or a security vulnerability in the network architecture by one medical entity could affect all of that entity's partners and unfairly expose a medial entity to unintended liability, penalties, damages, fines, and other costs. Inasmuch, there exists is an urgent need for a third party intermediary to broker access to electronic protected health information stored in disparate medical entity proprietary intranetworks while dynamically refreshing such access in accordance with user changes, changes from algorithms executed by an medical entity's network architecture, and changes in the existing governmental laws and regulations for health information including, among others security and privacy regulations, such regulations as, among others, the Security Standards for the Protection of Electronic Protected Health Information (the Security Rule) published Feb. 20, 2003 (45 C.F.R. Part 160 and Part 164, Subparts A and C) and established standards for protecting Health Information (ePHI) conveyed by electronic means (hence “ePHI”) (hereinafter referred to as “the ePHI security rule”); the Health Insurance Portability and Accountability Act (hereafter “HIPAA”) (Health Insurance Portability and Accountability Act of 1996 (HIPAA)); Public L. 104-191, 101 Stat. 1936, enacted Aug. 21, 1996), (see also the HIPAA Privacy Rule (See 45 C.F.R. § 164.530(c) (technical safeguards for ePHI)) and the HIPAA Security Rule (See 45 C.F.R. §§ 164.308, 164.310, and 164.312 (technical safeguards for ePHI)) (HIPAA Privacy and Security Rules refer to regulations for protecting the privacy and security of health information as developed by the Secretary of the U.S. Department of Health and Human Services (HHS).)); and the Health Information Technology for Economic and Clinical Health Act (HITECH Act) § 13410(d) (see eg. Meaningful Use (of Health Information Technology) Proposed Final Rule March/2012 (addressing the privacy and security concerns of ePHI)); HITECH Act as part of the American Recovery and Reinvestment Act of 2009 (ARRA), Public L. 111-5, enacted Feb. 17, 2009 (hereinafter, collectively, referred to as “The HITECH Act”).

Currently, privacy and security of electronic medical records are regulated by a complex patchwork of Federal, State and Local laws and regulations that control the transmission and/or sharing of electronic protected health information (ePHI). As an added option, although there is no known mechanism for individual medical entities to share privacy and security information that can affect partner medical entities. Typically either a patient or their representative must independently contact each medical entity. Accordingly, this process is often significantly arduous and confusing to many individuals with health concerns. Some states and medical facilities legally permit a patient to further restrict access to their medical records to exclude particular individuals or physicians although there presently is no known system and method for allocating a patient's directives in real-time to each medical entity that participates in that patient's care.

Recently, as trends in healthcare administration rapidly move from paper files and telephones toward mobile broadband device operations of the 21st century, the variety of and speed by which healthcare applications are offered by mobile devices continues to significantly improve. Under recent governmental regulations such as the HITECH and HIPAA Acts, today's healthcare administration practice, including radiological medicine, is moving toward benefiting from the advancements of mobile broadband and away from the “brick and mortar” legacy systems that promote analog paper files and imaging films as well as significantly arduous efforts in preparing, relocating, and updating each patient medical file. At times, paper patient signature paper forms lack uniformity with those forms of other healthcare systems to thus needlessly create expensive, legal ambiguity regarding a patient's authorized directives between healthcare systems as well as with accurate accounting for any patient updates.

HIPAA regulations typically restrict each medical entity from releasing ePHI information for purposes other than patient care and health care administration including billing. However, a medical entity is not restricted from sharing information with another medical entity for the purpose of an individual patient's care. Accordingly there exists a need for a centralized, computer-based exchange network for a patient to provide their directives in real-time and restrict access to their medical information. There is a further need of distributing patient directives to medical entities participating in the exchange. There is a further need monitoring a patient's directives, access authorizations, and ePHI collectively gathered by medical entities participating in the exchange to assist with updating by modifying a patient's authentication, authorizations, ePHI, and user interface.

As discussed above, the Meaningful Use provisions under the newly implemented HITECH Act now creates a financial incentive program for physicians and healthcare providers to adopt “meaningful use” of electronic medical records (EMR) as opposed to paper files. In effect, the “Meaningful Use” provisions have added increased standards for electronic transmission of medical records to qualify for financial incentives that are currently technically difficult and potentially quite costly to implement as many physician and healthcare provider system information technology network architectures are proprietary and incompatible with others.

To the tedious discomfort of every sick patient, this process of each healthcare system initially requiring the patient to fill out a HIPAA authorization form for accessing the patient's medical files is routinely repeated today, such as while the patient moves between healthcare systems including doctors' offices or if the patient's existing healthcare system lost the authorization form. This time-consuming, expensive, and highly bureaucratic protocol is often encouraged in that internal practices of healthcare administration from each healthcare system are different from that of most other healthcare systems. Illustratively, from a business perspective, each healthcare administration is not readily willing to share patient information while in the context of revealing sensitive aspects of that providing healthcare system's internal filing systems, procedures, and other proprietary investments to another healthcare system that create detrimental competitive and legal risks.

In this present paper-centric system, there exists no single or direct way to update access to an individual patients medical records. As patients frequently change providers or health professionals migrate between healthcare systems, the most current revisions to the paper authorization HIPAA forms for accessing a patient's medical files are always needed but rarely ever provided. Moreover, present day healthcare systems do not typically permit access to patient medical information over the internet although implementation of a patient portal is mandated for stage 2 compliance of the ARRA's “meaningful use” provisions.

Each revision to the present “brick and mortar” HIPAA authorization paper forms typically cannot be updated at just one time. Such revisions require that the petitioning patient, for each revised entry, to keep track of and update access to their patient records by providing several copies of the revised form to the many healthcare systems that have access to the patient's medical files. This daunting bureaucratic burden is often placed on the petitioning patient, which is often an insurmountable task for those patients who are not in the best of health to remain at such a high level of vigilance. For example, under the current Meaningful Use provisions of the HITECH Act, if a patient decides to prohibit a specific physician from continuing to view that patient's electronic protected health information, ePHI, then the patient would often need to ensure that the same update is both directly and indirectly made to a variety of different healthcare systems in that often a single physician maybe placed in several hospital and clinical network systems, such as among others, an imaging center system, a hospital system with a referring physician, and a radiologist clinical network system.

Health care professionals are currently beginning to use mobile devices to access patient ePHI from multiple, often incompatible, medical entities. Mobile device access to ePHI is achieved typically with software downloads that regrettably remain on that mobile device even after completion of a login session. As an undesired consequence in terms of privacy and security regulations, the downloaded software often stores information directly to the mobile device after each login session including ePHI of numerous patients, login information, and information to several medical entity portals. If the information remaining on a mobile device is compromised, it can take some time for the user to recognize that the specific mobile device is lost, and even longer to contact all of the effected medical entities so that the entities can take the appropriate steps to change the compromised user's login privileges, protect the ePHI residing in the mobile device from a further breach, and, potentially, notifying effected the patients with compromised ePHI as required by HITECH regulations.

Unfortunately, presently known accounting systems for patient HIPAA privacy authorizations cannot be updated in real-time, are not reliable in determining all who have gained access to such patient information, and may contain network infrastructure that could inherently compromise patient medical privacy. There is a critical need for today's healthcare administrators to provide single, controlled access to an individual patient's medical information that remains remotely stored within internal network architecture from a variety of disparate healthcare professionals, medical systems, and vendors networks. There exists a further need to edit the single, controlled access to each patient's medical information in real-time over the internet such that respective plurality of healthcare network systems are each updated in real-time. There exists a need for a cloud-based vetting system for providing user access to a plurality of, often incompatible, healthcare network systems that collectively maintain a patient's electronic protected health information through assigning and updating a user token, at the cloud-based vetting system, that facilitates government regulatory security and privacy of while accessing a patient's ePHI.

Accordingly, there exists a need for a system and method for patient access via an ePHI-compliant gatekeeper system that is an independent, cloud-based architecture to ensure that inherent infrastructure does not compromise existing privacy requirements and the proprietary interests of partnered platformed networks.

There exists a need for a cloud-computing based system to service as a centralized repository for users that are registered with the system and their corresponding authentications and authorizations to ePHI located on participating medical entities. Once notified of compromised information, each user registered with the system can notify each compromised user and initiate breach mitigation protocols including modifying each compromised users login privileges.

Generally, within the broader field of radiology, there exists a need for electronic patient access through an ePHI-compliant gatekeeper system that is cloud-based for patient medical files that include patient imaging.

### BRIEF DESCRIPTION OF THE FIGURES

The accompanying figures, where like reference numerals refer to identical or functionally similar elements throughout the separate views, together with the detailed description below, are incorporated in and form part of the specification and serve to further illustrate various embodiments of concepts that include the claimed invention, and to explain various principles and advantages of those embodiments.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments. In addition, the description and drawings do not necessarily require the order illustrated. It will be further appreciated that certain actions and/or steps may be described or depicted in a particular order of occurrence while those skilled in the art will understand that such specificity with respect to sequence is not actually required.

FIG. 1, in general, is a system diagram illustrating an ePHI-complaint gatekeeper system in accordance with embodiments of the present disclosure featuring a cloud-based vetting system for interfacing with user equipment, the cloud-based vetting system features a Platform as a Service (PaaS) module that electronically provides real-time updated, single controlled access to individual patients medical information, accordingly, the cloud-based vetting system provides an infrastructure application that is a plugin component to a plurality of network entities that maintain such medical information;

FIG. 2, is a sequence diagram of an ePHI-compliant gatekeeper system featuring a cloud-based vetting system, a builder entity, and a plurality of users, the sequence diagram features a plurality of sequence algorithms including, among others, a user invitation sequence, a user augmentation sequence, and a quarantine augmentation sequence;

FIG. 3, is a bit layout of one illustrative embodiment of a token packet header featuring a master token coupled to a plurality of subtokens, a matrix is schematically shown to correlate registrant user permitted authorizations and restricted authorizations so as to activate only the permitted authorizations to build the token packet header with corresponding activated subtokens;

FIG. 4 is a system diagram illustrating one embodiment of an ePHI-complaint gatekeeper system featuring a Synchronization as a Service module; and

FIG. 5 is a system diagram illustrating one embodiment of an ePHI-complaint gatekeeper system featuring a Synchronization as a Service module.

Apparatus and method components have been represented where appropriate by conventional symbols in the drawings, showing only those specific details that are pertinent to understanding the various embodiments so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

### DETAILED DESCRIPTION

Generally speaking, pursuant to the various embodiments, the present disclosure provides a system and method for healthcare administration and, in particular, manages, via an ePHI-compliant gatekeeper system, user access to at least one network from a plurality of networks that are platformed with the ePHI-complaint gatekeeper system, where the ePHI-compliant gatekeeper system ensures real-time updates to user access authentications and authorizations, among other operations. Generally, pursuant to the various embodiments, the present disclosure provides an ePHI-compliant gatekeeper system for user access, through at least one user equipment. In one aspect, the user is assigned to more than one user equipment where user equipment, includes, among others, a mobile device, fixed kiosk, and computer-based work station. The ePHI-compliant gatekeeper system includes a cloud-based vetting system that is communicatively connected to the at least one user equipment. In one aspect, the cloud-based vetting system includes a subscriber application. The subscriber application is communicatively connected to the user equipment and receives registration information including ePHI from the user via the user equipment.

The subscriber application includes an authentication application that is communicatively connected to at least one platformed network. Based on registration information including ePHI, the authentication application authenticates the petitioning user for access to the at least one platformed network.

Similarly, in one aspect, the cloud-based vetting system includes an authorization application that is communicatively connected to the at least one platformed network. Based on registration information including ePHI, the authorization application generates a token that corresponds to the specific user. The token provides a plurality of user-specific authorizations as the user access the at least one platformed network. In one aspect, as the token is based on the authorizations of a specific user, user authorizations to the at least one platformed network vary according to the token that is assigned to each specific user.

Illustratively, the ePHI-compliant gatekeeper system is applicable to the field of radiology, among other fields. Accordingly, users, such as either patients or enterprises for example a medical facility, interface with the cloud-based vetting system through a variety of user equipment, for example a wireless mobile device, a kiosk, and a fixed computer-based work station. Specifically, the cloud-based vetting system includes a web frontend module. In operation, to communicatively connect with the cloud-based vetting system, the user interfaces directly with the web frontend module through the user equipment. As such, registration information and ePHI is entered directly to the cloud-based vetting system through the web frontend module such that data never remains on the user equipment to thereby compromise user privacy, such as a patient's privacy under HIPAA.

Next, to ensure identity, the user is authenticated by the cloud-based vetting system through the subscriber application. Once the user's identity is authenticated by the cloud-based vetting system, an authorization application is further provided by the cloud-based vetting system to processes, in real-time, what current authorizations are permitted for the specific authenticated user.

Moreover, through a web backend module, the authorization application is interfaced with at least one platformed network. Accordingly, once the cloud-based vetting system has authenticated the user's identity and assigned the appropriate authorizations, then the cloud-based vetting system enables that user to access desired medical information by permitting entry to the corresponding platformed network for maintaining such medical information.

Illustratively, a patient, as the petitioning user, accesses the cloud-based vetting system with their mobile phone such that the cloud-based vetting system authenticates and authorizes that user to view their radiologic images at an imaging center platformed network that has built their network infrastructure to include the platformed cloud-based vetting system. Furthermore, the patient updates, in real-time, through an updater those who are authorized to view their radiological images through a Platform as a service (PaaS) infrastructure. Illustratively, in one aspect, the PaaS module of the cloud based vetting system provides an updater, such as for example to either permit or restrict medical professionals from viewing a patient's particular radiologic image.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments. In addition, the description and drawings do not necessarily require the order illustrated. It will be further appreciated that certain actions and/or steps may be described or depicted in a particular order of occurrence while those skilled in the art will understand that such specificity with respect to sequence is not actually required.

Apparatus and method components have been represented where appropriate by conventional symbols in the drawings, showing only those specific details that are pertinent to understanding the various embodiments so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

Illustrative embodiments of the present disclosure and appended claims, as described below, are generally applicable to the ePHI-compliant gatekeeper system that includes user equipment (UE), a cloud-based vetting system, and a plurality of networks. In one aspect, the plurality of networks includes networks based on network infrastructure of a type well known in the industry, such as internet protocol network architecture, TCP/IP. Each of the plurality of networks based on infrastructure well known in the industry includes, among others, a number of infrastructure devices for facilitating communications for the user equipment and operating in the system. Such infrastructure devices include elements of a radio access network (RAN) or simply access network that communicate with the subscriber units via an air interface, such as for instance, eNodeBs, base radios, base stations, base transceiver stations, and the like. Such infrastructure devices further include elements of an infrastructure core (e.g., a UMTS-3G core network for a 3G or GSM/EDGE system; an Evolved Packet Core (EPC) in an LTE system etc.) used to manage the allocation of radio resources of the network, with the infrastructure core including elements such as for instance, Mobility Management Entities, Signaling Gateways, Health Level 7 (HL7) MTS adapter core engines, Packet Data Network Gateways, etc. Other infrastructure devices that may be included in any one or each of the disclosed networks includes, but are not limited to, switches, zone controllers, base station controllers, repeaters, access points, routers, etc.

In one aspect, the plurality of platformed networks of the ePHI-compliant gatekeeper system includes networks based on network infrastructure of a type well known in the industry, such as internet protocol network architecture, TCP/IP. Illustratively, in one embodiment among others, the plurality of platform networks includes any combination of a pharmacy network, a social network, a hospital/clinical network, an imaging center network, a radiologic network, and a virtual private network such as among others a Picture Archiving and Communication System (PACs) and a Radiology Information System (RIS).

Illustratively, and at least in one aspect, each network from the plurality of platformed networks may comprise either a private 3G or GSM/EDGE system for supporting HL7 such as among others a hospital network 3G system or a public 3G system such as among others a commercial carrier commercial mobile phone EDGE system. Alternatively, each network from the plurality of platformed networks may comprise either a private 4G Long Term Evolution (LTE) system for supporting m-health, such as among others a hospital network 4G LTE system or a public 4G LTE system, such as among others a commercial carrier for mobile 4G LTE systems.

In at least one aspect, the plurality of platformed networks may include at least one network includes an International Mobile Telecommunications-2000 (IMT2000) based network designed to meet IMT-2000 standards, such as among others a private radiologic imaging center or a public 3G system, such as among other a commercial carrier mobile 3G systems. However, the plurality of networks can comprise any combination of 3GPP (3rd Generation Partnership Project), broadband, legacy or non-3GPP radio access type systems including but not limited to LTE systems, Wireless Local Area Network (WLAN) systems, and Code Division Multiple Access (CDMA) systems, GPRS (general packet radio service) systems, Land Mobile Radio (LMR) systems, and WiMAX (Worldwide Interoperability for Microwave Access) systems. Among other messaging applications, mobile devices and other telecommunication systems are increasingly relying on internet protocols such as Session Initiation Protocol (SIP) for creating, modifying, and terminating communication sessions with one or more participants using a combination of multimedia applications, such as for voice and video.

In one aspect, the cloud-based vetting system is based on cloud computing infrastructure. For purposes of illustration in this disclosure and appended claims, the cloud-based vetting system, in one aspect, comprises a self-hosted private cloud. In other aspects, the cloud-based vetting system is applied to either a dedicated public cloud or, alternatively, a partner-hosted private cloud. Those of ordinary skill in the art will readily recognize any applicable cloud computing infrastructure for the cloud-based vetting system.

At times, as described herein for purposes of this disclosure and appended claims, the terms among others “Patients”, “Medical Facilities”, “Physician”, “Healthcare Professional”, “Healthcare Administrator”, “Billing Professional”, “Heath Provider”, “Pharmacist”, “Combat Medic/Corpsman”, “Information Technology Professional”, “Technician”, “Imaging Center”, “Peer”, “Administrator”, “Originator”, “Participant”, “Node”, “User”, “User Agent Client”, “Client”, “User”, “Petitioning User”, “Requesting User”, “Subscriber(s)” and “Source/Destination Endpoint” are used interchangeably for a logical network endpoint that transmits or receives Internet Protocol messages such as among others SIP messages through a user agent server. It is understood that “user” or “subscriber” refers to one or more operators of user equipment (UE). Those of ordinary skill in the art will readily recognize various embodiments of UE, for purposes of illustration in this disclosure, the UE comprises either a wireless mobile device, such as among others a smart phone or tablet computer, or a wired device, such as among others a desktop computer, work station or a kiosk. Moreover, as described herein for purposes of this disclosure and appended claims, the terms “radiology” and “teleradiology” are used interchangeably for field of radiological medicine.

The users can be members of a “work request group”, “group” or “talk group” that include a combination of preconfigured users, ad hoc users or members. Alternatively, subscribers may not be members of such groups. As described herein, a communication group in an ePHI-compliant gatekeeper system is referred to as a “network entity”, “network entities”, “network system”, “network groups”, “social network group” or “group”. An ePHI-compliant gatekeeper system features a plurality of network entities where it is possible for a user to be a member of any combination of groups and users. Illustratively, in one embodiment, a radiologist as a user accesses the cloud based vetting system which authenticates and authorizes the radiologist so as to access a desired imaging center as a network entity, whereby the network entity is platformed with the cloud based vetting system, provides images for a desired patient to the radiologist. Moreover, the patient then accesses the cloud based vetting system for authentication and authorization to video conference with the radiologist via broadband multimedia conferencing provided by the platformed Radiologist network entity to discuss the radiologist's report. As a further illustration, an endpoint, such as case manager assigned by a referring physician for managing a particular patient, may be a concurrent member of a clinical network entity, a radiology network entity, and a social network entity.

In this disclosure and appended claims the term “real time” “real-time” refers to denoting or relating to a computer system that constantly updates information at the same rate as the system receives data, and processes data sufficiently rapidly to be able to control a process.

In this disclosure and appended claims the term “data input” and “input” refers to data that is provided through user equipment to the cloud-based vetting system. In particular, each user engages in a direct communication session with the cloud-based vetting system by way of any combination of UE comprising hardware and software and/or firmware. The UE interfaces with the cloud based vetting system such that all input is directly received by the cloud based vetting system and does not remain on the interfacing UE.

In this disclosure and appended claims, the terms “Protected Health Information, PHI”, “electronic Protected Health Information, ePHI”, “ePHI related data”, “electronic health records”, “medical information”, “medical records”, “private information”, “patient medical file”, “patient information”, “health records”, “health information”, “health information technology” refer to health information that is protected by government regulations and industry standards, among other means for protection, and includes, among others security and privacy regulations, such regulations as, among others, the Security Standards for the Protection of Electronic Protected Health Information (the Security Rule) published Feb. 20, 2003 (45 C.F.R. Part 160 and Part 164, Subparts A and C) and established standards for protecting Health Information (ePHI) conveyed by electronic means (hence “ePHI”) (hereinafter referred to as “the ePHI security rule”); the Health Insurance Portability and Accountability Act (hereafter “HIPAA”) (Health Insurance Portability and Accountability Act of 1996 (HIPAA)); Public L. 104-191, 101 Stat. 1936, enacted Aug. 21, 1996), (see also the HIPAA Privacy Rule (See 45 C.F.R. § 164.530(c) (technical safeguards for ePHI)) and the HIPAA Security Rule (See 45 C.F.R §§ 164.308, 164.310, and 164.312 (technical safeguards for ePHI)) (HIPAA Privacy and Security Rules refer to regulations for protecting the privacy and security of health information as developed by the Secretary of the U.S. Department of Health and Human Services (HHS).)); and the Health Information Technology for Economic and Clinical Health Act (HITECH Act) § 13410(d) (see eg. Meaningful Use (of Health Information Technology) Proposed Final Rule March/2012 (addressing the privacy and security concerns of ePHI)); HITECH Act as part of the American Recovery and Reinvestment Act of 2009 (ARRA), Public L. 111-5, enacted Feb. 17, 2009 (hereinafter, collectively, referred to as “The HITECH Act”). In at least one embodiment, ePHI includes information associated with user identification and authorization.

In this application and appended claims the term “registration information” refers to information provided by each user on either registration or login with an ePHI-compliant gatekeeper system and such registration information includes, among others, user identification information, authentication information, synchronization information, and ePHI. For example, registration information includes, among others: the user or patient's name, social security number, date of birth, and, optionally, biometric scan data, insurance policy number, and the medical entity ID number if the user is an employee.

In this disclosure and appended claims the terms “platformed”, “platformed network” refer to a network that includes a cloud-based Platform as a Service (PaaS) application with its network infrastructure. Illustratively, a radiologic imaging center incorporates the cloud-based vetting system, as a PaaS application module, into the imaging center's network infrastructure as a means for providing independently verified user access to radiologic imaging information to patients who wish to review their image files electronically while connected to the internet. As such, the cloud-based vetting system, as a component of the imaging centers infrastructure, ensures that the requesting patient is initially screened in accordance with HIPAA and other privacy and security protocols applied with the cloud-based vetting system before the patient views their image that is stored within imaging center's internal network infrastructure.

In this application and appended claims the term “header template”, “template” allows a function application to work on many different data types without being rewritten for a user login session such that an arrangement of templates for each login session is provided, for example, at a data packet that includes a header template whereby the data packet defines, at least in part, a token. Those of ordinary skill in the art will readily recognize that other embodiments will use a “template” and “header template” for more than one login session.

In this application and appended claims, the term “token” refers to at least one data packet assigned to a user of an ePHI-compliant gatekeeper system that includes user-specific information such as, among others, user authorization information and user authentication information. In one embodiment, the user-specific information is updated and synchronized. In this application and appended claims the term “trigger” refers to an external stimulus that engages a functional response by the cloud-based vetting system.

While embodiments of the present disclosure employ various teachings of the aforementioned standards and protocols, the embodiments as described herein are not limited by these protocols. Those skilled in the art will realize that the above recognized advantages and other advantages described herein are merely illustrative and are not meant to be a complete rendering of all of the advantages of the various embodiments.

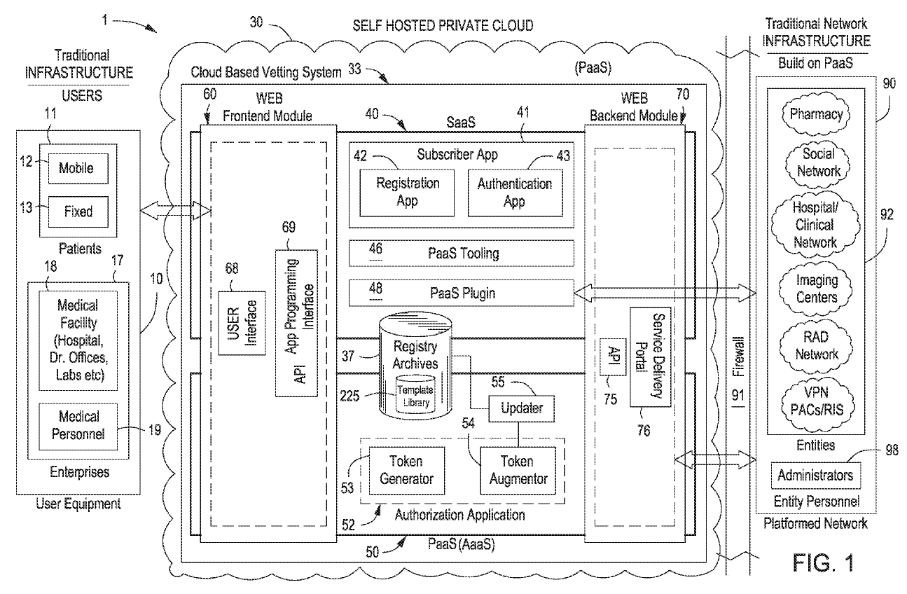

Referring now to the figures, FIG. 1 generally illustrates an ePHI-complaint gatekeeper system 1 and provides a general depiction of the physical implementation of various embodiments of the present disclosure. Specifically the ePHI-compliant gatekeeper system 1 includes users having at least one user equipment 10. The users access the cloud-based vetting system 33 with at least one user equipment 10.

The ePHI-compliant gatekeeper system 1 further includes at least one platformed network 90. Generally, the at least one platformed network 90 includes a plurality of network entities 92. For example, among others, the plurality of network entities 92 comprise hospital networks, clinical networks, imaging centers network systems, radiologic networks, pharmacy networks, social networks, and, generally, virtual private networks, such as among others a Picture Archiving and Communication System (PACs) and a Radiology Information System (RIS). In at least one embodiment, the at least one platformed network 90 comprises a virtual private network such as among others a Picture Archiving and Communication System (PACs) and a Radiology Information System (RIS).

In operation, these network entities 92 provide ePHI related data to the user at the requesting user equipment 10. This ePHI information is provided to the user only after the cloud-based vetting system 33 permits the petitioning user to access the desired network entity from the plurality of network entities 92 that maintains the requested ePHI related data.

Generally, as shown in FIG. 1, each network entity 92 of the plurality of platformed networks 90 build their respective network infrastructures to include a Platform as a Service (PaaS) application module provided by the cloud-based vetting system 33, as discussed in detail below. The cloud-based vetting system 33 features a Platform as a Service (PaaS) module 50 that electronically provides real-time updated, controlled user authorization to individual patients' medical information as an infrastructure application that is an integrated component to each network entity of the plurality of network entities that maintain such medical information. Similarly, the cloud-based vetting system 33 features a Software as a Service (SaaS) module 40 that electronically provides real-time updated, single controlled user authentication while petitioning the cloud-based vetting system 33 for access to individual patients' medical information collectively provided by the at least one platformed network 90.

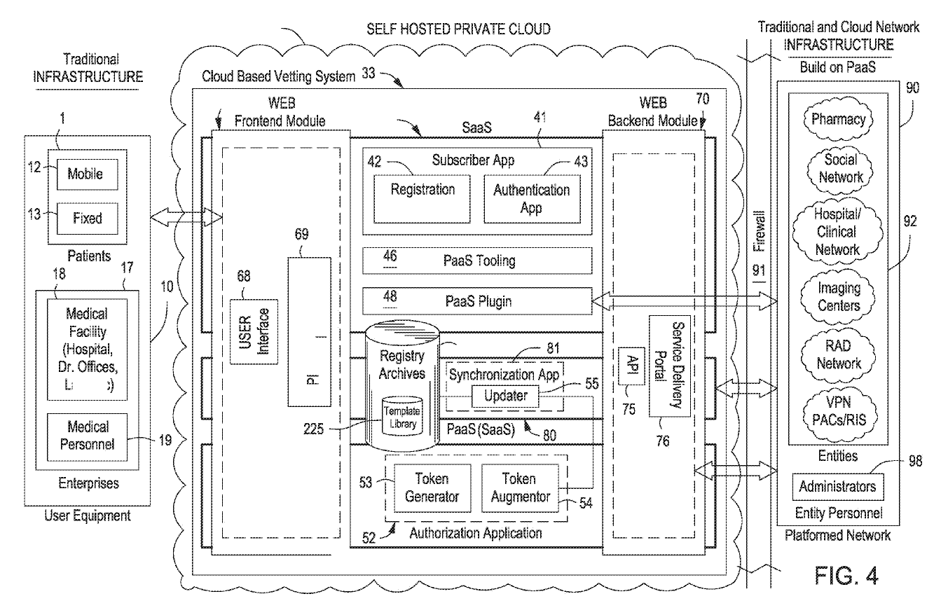

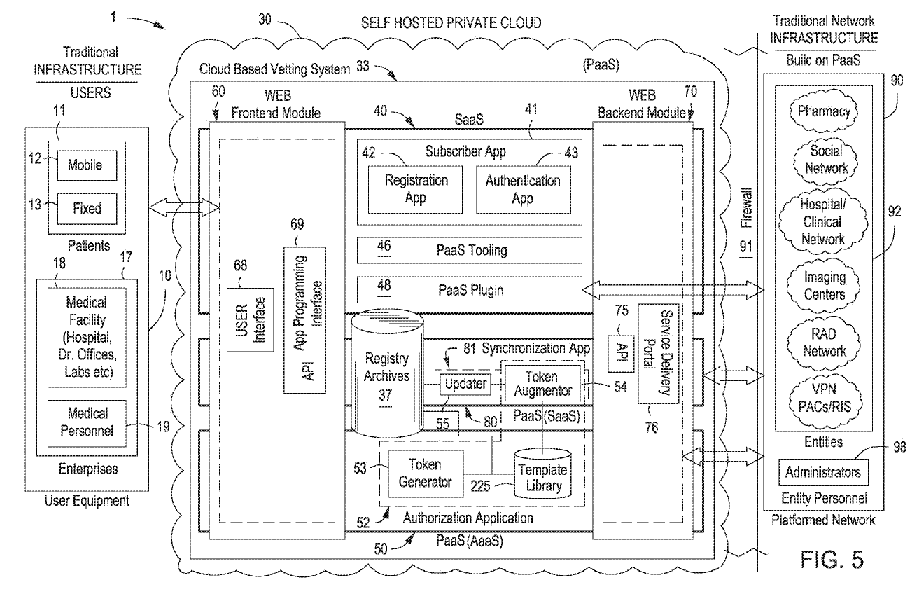

Optionally, as shown in FIGS. 4-5, the cloud-based vetting system 33 further includes a Synchronization as a Service (SaaS) module 80 coupled to the at least one platformed network 90, the SaaS module 40 and the PaaS module 50. In operation, as discussed in detail below, the Synchronization as a Service (SaaS) module 80 is a special instance of a Platform as a Service module such that the Synchronization as a Service (SaaS) module 80 ensures that any ePHI provided by the at least one platformed network 90 in real-time is synchronized with ePHI provided by users at login with the cloud-based vetting system 33.

Those of ordinary skilled in the art will readily recognize that any combination of a SaaS module 40 and a PaaS module 50 may define the cloud-based vetting system 33. For example, one embodiment of the cloud-based vetting system 33 is defined by a SaaS module 40 whereas, in an alternative embodiment, the cloud-based vetting system 33 is defined by a PaaS module 50.

Accordingly, the cloud-based vetting system 33 ensures that the correct individual requesting the medical files is authenticated with the SaaS module 40 such that individual currently has the appropriate authorizations with the PaaS module 50 to access such medical information that is stored in the at least one platformed network 90. In one embodiment, the cloud-based vetting system 33 is an independent plugin that integrates with each network entity 92 such that the each user is independently vetted according to HIPAA, HITECH, and other predetermined requirements before accessing the desired network entity 92.

For the embodiment of FIG. 1, the at least one platformed network 90 is provided by the ePHI-compliant gatekeeper system 1. For illustrative purposes in this application and appended claims, as shown, the at least one platformed network 90 is associated with a radiology practice that includes a plurality of network entities 92 associated with radiological medicine. Those of ordinary skill in the art will recognize that other platformed networks 90 provided by the ePHI-compliant gatekeeper system 1 (not shown) each platformed network corresponding to a variety of medical practices such as oncology, internal medicine, cardiology, surgery, laboratory medicine etc.

As shown, each network entity of the plurality of network entities 92 is communicatively connected to the cloud-based vetting system 33. In FIG. 1, the cloud-based vetting system 33 includes a PaaS plugin 48. Operatively, the PaaS plugin 48 assists network infrastructure developers on the at least one platformed network 90 in receiving the necessary software and/or hardware for seamlessly interacting with the functional applications provided by the cloud-based vetting system 33. In one embodiment, a PaaS plugin 48 is received by each network entity 92 to integratively platform the cloud-based vetting system 33 thereto. For purposes of illustration as related to radiological medicine for the at least one platformed network 90, the plurality of network entities 92 includes a pharmacy network, a social network based system, a hospital/clinical network, imaging center networks, radiologists' network, and a virtual private network such as a PACs/RIS.

Moreover, the cloud-based vetting system 33 further includes PaaS tooling 46. In operation, the PaaS tooling 46 provides the requisite combination of software and hardware infrastructure for coupling the at least one platformed network 90 with the cloud-based vetting system 33 as the PaaS plugin 47 is received by each network entity. In operation, the PaaS tooling 46 and PaaS Plugin 47 cooperate to provide the functional tools offered by the cloud-based vetting system 33, such as user authentication and authorization tools, as a component system of each platform entity 92 as each platformed entity 92 develops its network systems.

With further reference to the embodiment of FIG. 1, the at least one platformed network 90 further includes entity personnel 98. For example, among others, the entity personnel 98 include information technology and network administrators. Accordingly, in one embodiment, each administrator from a corresponding network within a plurality of network entities 92 is communicatively connected, across a network security firewall 91, to the cloud-based vetting system 33. In one embodiment, each administrator from a corresponding network within a plurality of network entities 92 is continuously connected, across a network security firewall 91, to the cloud-based vetting system 33.

For the embodiment of FIG. 1, the ePHI-compliant gatekeeper system provides the network security firewall 91 between the cloud-based vetting system 33 and the at least one platformed network 90. Generally, the network security firewall 91 ensures that the at least one platformed network 90 is secure and, specifically, protects the ePHI such as patient medical files, images as well as prescriptions that are collectively stored in the various platformed entities of the plurality of platformed entities 92. In operation, the cloud-based vetting system 33 is permitted to enter through the network security firewall 91 to communicatively connect with each platformed entity of the plurality of platformed entities 92, via each respective PaaS plugin 48 that is downloaded by each platformed entity.

Operatively, the cloud-based vetting system 33 is permitted, in part, as a Platform as a Service as well as a Software as a Service, to communicatively connect, through the firewall 91, with the at least one platformed network 90. The cloud-based vetting system 33, through a combination of authentication and authorization, discriminately provides user access to ePHI related data, including private and, often, network-proprietary patient medical information, that is collectively maintained within the plurality of network entities 92.

In operation, the cloud-based vetting system 33 permits each administrator of a platformed entity to change any combination of user authentications and authorizations in real-time. Accordingly, in one embodiment, the at least one platformed network 90 is communicatively connected to the cloud-based vetting system 33 with an HL7-based connection.

Optionally, as shown in FIGS. 4-5, the cloud-based vetting system 33 further includes a Synchronization as a Service (SaaS) module 80 coupled to the at least one platformed network 90, a registry archives 37, the SaaS module 40, and the PaaS module 50. In operation, the Synchronization as a Service (SaaS) module 80 is a special instance of a Platform as a Service module such that the Synchronization as a Service (SaaS) module 80 ensures that any ePHI provided by the at least one platformed network 90 is synchronized in real-time with ePHI provided by users at login with the cloud-based vetting system 33 to ensure that ePHI, including user identification and authorization information, and registration information are maintained at the registry archives 37 is continuously updated. The updated ePHI at the registry archives 37 is provided to the authorization application 52 and the authentication application 43 to ensure updated ePHI and registration information is applied when generating or modifying tokens for each login session.

Illustratively, if a user failed to renew their physician's licensure with various credentialing boards, then a network administrator at the user-physician's Hospital network entity 92 updates that physician's authorizations on the cloud-based vetting system 33 to restrict the physician from practicing medicine until the credentialing is renewed. In particular, the cloud-based vetting system 33 subsequently prevents the physician's access to the plurality of network entities 92. In one embodiment, any network entity 92 can restrict user subsequent user logins.

In one other example, a network administrator accesses the cloud-based gatekeeper system 33 to restrict authentication of an ex-employee at login with the cloud-based vetting system 33 so that the ex-employee can no longer access, via the cloud-based vetting system 33, any ePHI data such as among others highly sensitive individual patient medical information provided by each of the plurality of network entities 92 on the at least one platformed network 90. Furthermore, as discussed in detail below, an information technology administrator 98 accesses the cloud-based vetting system 33 to readily contain a security breach in the event that a patient's ePHI is compromised so as to restrictively quarantine login access at the cloud-based vetting system 33 to those users directly involved with that compromised ePHI.

In one aspect, at least one user equipment 10 operates on networks based on network infrastructure of a type well known in the industry, such as internet protocol network architecture, TCP/IP. Alternatively, at least one user equipment 10 operates on any combination of cloud-based and traditional network infrastructure that is readily recognizable by those of ordinary skill in the art.

For the embodiment of FIG. 1, users are generally patients and enterprises. Accordingly, the type of user equipment 10 operated by users are shown to indicate the role by which the user equipment 10 will function for a login session, such as for illustrative purposes among others as patients' user equipment 11 and enterprises user equipment 17.

In one embodiment, patients' user equipment 11 includes mobile user equipment 12 and fixed user equipment 13. The mobile user equipment 12 includes, among others, a wireless mobile device such as among others a mobile computing platform, a smart phone, a tablet computer and a laptop. The fixed user equipment 13 includes, among others, a kiosk and a computer work station.

Illustratively, in operation, a multiple myeloma cancer patient as a user of the ePHI-compliant gatekeeper system 1 initially accesses the cloud-based vetting system 33 with a smart phone as a mobile user equipment 12. Through the smart phone, the cloud-based vetting system 33 ensures the identity of the cancer patient and verifies authorizations for the patient to access their imaging center as well as the pharmacy network, each of the plurality of network entities 92, to gain updated perspectives on the extent of their disease by viewing bone images from the imaging centers' network and a chronological summary of prescribed medicinal dosages from the pharmacy network.

As further shown m FIG. 1 enterprise user equipment 17 includes medical facility equipment 18 and medical personnel equipment 19. Generally, the medical facility user equipment 18 permits hospital systems, doctors' office networks, reference laboratories to gain access to ePHI related data, via the cloud-based vetting system 33, in the same manner as that of an individual patient 11. For the embodiment shown in FIG. 1, among others, the medical facility user equipment 18 permits network administrators of hospital systems, doctors' office networks, reference laboratories to gain access to ePHI related data, via the cloud-based vetting system 33, in the same manner as that of an individual patient 11. In one exemplary embodiment, the medical facility equipment 18 includes computer systems on virtual private networks. Accordingly, the cloud-based vetting system 33 ensures the identity of the medical facility enterprise 92 that is petitioning, via the medical enterprise user equipment 18, for access to patient medical information. In one embodiment, the cloud-based vetting system 33 further determines what specific ePHI related data the petitioning medical facility 92 is authorized to access for each login request.

For the embodiment of FIG. 1, the medical personnel equipment 19 refers to user equipment used by individual healthcare professionals that must frequently gain access to ePHI data for a variety of patients. Examples, among others, of individual healthcare professionals that use medical personnel equipment 19 include a physician, a healthcare professional, an healthcare insurance professional, a pharmacist, an academic researcher, and a radiology network professional. Accordingly, whereas the medical enterprise user equipment 18 is generally provided by a medical facility Information Technology administrator 98, the medical personnel equipment 19 is not necessarily provided by an Information Technology administrator 98 which includes among others a personal smart phone, tablet, mobile computing device, and external network computer.

In the same manner as described above, medical personnel equipment 19 permits a user to access a user interface 68 provided by the cloud-based vetting system 33 to initiate the process of accessing a desired network entity 92, such as an imaging center, on the at least one platformed network 90. As such, the cloud-based vetting system 33 ensures the identity of the user that is petitioning, via the medical personnel equipment 19, for access to patient medical information. In one embodiment, the cloud-based vetting system 33 further determines what specific ePHI data the petitioning user is authorized to access for each information request at login.

Illustratively, a referring oncologist makes a specific patient inquiry while on medical personnel equipment 19, such as a personal tablet computer, to view both a final radiologists report from the radiologist network as well as images from the imaging center, each of the plurality of network entities 92. As the cloud-based vetting system 33 has already authenticated the oncologist's identity, the oncologist, while on a personal tablet computer, then provides an electronic prescription for Thalidomide directly to the platformed pharmacy network of the plurality of network entities 92.

Referring to FIG. 1, the cloud-based vetting system 33 generally includes the Software as a Service (SaaS) 40 module and the Platform as a Service (PaaS) 50 module. In at least one embodiment, each module 40, 50 comprises an application function.

Furthermore, as shown in FIG. 1, the cloud-based vetting system 33 includes a web frontend module 60 and a web backend module 70. The web frontend module 60 is layered to communicatively connect with both the SaaS module 40 and the PaaS module 50. Similarly, the web backend module 70 is layered to communicatively connect with both the SaaS module 40 and the PaaS module 50. The web frontend module 70 and the web backend module 70 are each communicatively connected to at least one user equipment 10. The web frontend module 70 and the web backend module 70 are each communicatively connected to the at least one platformed network 90.

The SaaS module 40 of the cloud-based vetting system 33 includes a subscriber application 41. The subscriber application 41 is communicatively connected, via the web frontend module 60, to at least one user equipment 10. The subscriber application 41 receives registration information including ePHI from the user via at least one user equipment 10 as shown.

The subscriber application 41 for the embodiment of FIG. 1 includes a registration application 42 and an authentication application 43. The authentication application 43 is communicatively connected to the at least one platform network 90 and to at least one user equipment 10 via the web backend module 70 and frontend module 60, respectively.

The registration application 42 is communicatively connected to at least one user equipment 10, the authentication application 43, and the registry archive 37. In operation, the registration application 42 is a Software as a Service application that obtains, from the petitioning user through user equipment 10, registration information including ePHI that includes an electronic HIPAA signature authorization form. Generally, the registration information obtained by the registration application 42 is directed toward the identifying the user petitioning for access to the cloud-based vetting system 33 as a matter of user authentication. The registration information specifically includes information that is obtained by the registration application 42 and stored in the registry archive 37 as the user initially registers with the cloud-based vetting system 33. The registration application 42 provides registration information that is associated with the user to the registry archive 37.

For example, the registration information that is obtained by the registration application 42 includes: the user or patient's name, social security number, date of birth, and, optionally, biometric scan data, insurance policy number, and the medical entity ID number if the user is an employee. In one embodiment, the registration information includes ePHI such as, among others, a user's social security number, a patient name, and executed electronic HIPAA release authorization and acknowledgement forms. In another embodiment, the registration information that is obtained from a health care professional by the registration application 42 includes, among others, a professional licensure include an expiration date, a National Provider Identification (NPI) number, and a US Drug Enforcement Agency (DEA) number.

During the initial registration process, the registration application 42 assigns a cloud-based vetting system identification code to the registering user and that is subsequently stored in the registry archives 37. Moreover, for security purposes such as creating a security subtoken 231 as discussed below, the registration application 42 identifies all user equipment assigned to each user and determines whether the user equipment features security applications that are compatible with the ePHI-compliant gatekeeper system 1.

Upon completion of the initial registration process, the subscriber application 41 facilitates storage and updating of the registration information initially received by the Registration Application 42 from user registration via, respectively, the registry archives 37 and updater 55, each provided by the cloud-based vetting system 33. Accordingly, this registration information is subsequently accessed by the authentication application 43 from the registry archives 37 to authenticate the corresponding user that is petitioning the cloud based vetting system 33 for electronic access to ePHI collectively stored on the at least one platformed network 90 among other applications. In one embodiment, the authentication application 43 based on the registration information authenticates the identity of the user for access to the at least one platformed network 90.

Therefore, after initially registering with the cloud-based vetting system 33, the authentication application 43 subsequently confirms the identity of the user at login. In general, the authentication application 43 matches the information provided by a specific user at each user login to the cloud-based vetting system 33 with corresponding registration information stored in the registry archives 37 to authenticate the petitioning user for access to the at least one platformed network 90. Moreover, the initial registration information provided by the user during registration is updated via the subscriber application 41 to reflect any changes to the information since initial registration and stored in registry archives 37 for use by the authentication application 43 to subsequently authenticate the user. The registry archive 37 maintains the registration information.

Illustratively, while logging-in as a user with the cloud-based vetting system 33, a physician provides the cloud-based vetting system identification code assigned by the cloud-based vetting system 33, password, and biometric scan such as an iris scan, fingerprint scan, facial recognition, voice recognition or other biometric identification device taken from a mobile tablet computer as medical personnel equipment 19, and optionally, a social security number, date of birth, and medical facility ID number are further provided at login. With the web frontend module 60, the SaaS module 40 receives the physician provided login information. The authentication application 43 compares such information with corresponding registration information relating to the petitioning physician that is stored in the registry archives 37 to authenticate the identity of the physician.

In another illustration, while at their pharmacy, a patient logs into the ePHI-compliant gatekeeper system 1 with a kiosk as user equipment 13 and successfully authenticates. At the kiosk, the patient accesses a list of users and user groups that are authorized to view that patient's medical records. The list of authorized ePHI users is created at the cloud-based vetting system 33 from the existing data provided during the initial patient registration and by entity personnel 98, such as network administrators, that the patient permits, through electronic HIPAA authorization forms and releases including the HIPAA statement of understanding form when applicable, to access to that patient's ePHI. From this updated list of authorized ePHI users, the patient at the illustrative kiosk session then designates the specific ePHI users that can access their entire ePHI file and limits the categories of medical records that can be viewed. For instance, while at the kiosk, the patient restricts access to the following categories of mental health records, drug treatment records, and HIV status to specific ePHI users.

The web frontend module 60 permits at least one user equipment 10 external to the cloud-based vetting system 33 to interface with cloud-based vetting system 33. In one embodiment, the web frontend module 60 includes a user interface 68 to enable the user to navigate the features provided within the cloud-based vetting system 33.

In one exemplary embodiment, the user interface 68 includes at least one graphical user interface (GUI). In operation, users, through at least one user equipment 10, interact with the user interface 68 to directly access the cloud-based vetting system 33 to ultimately gain access to desired ePHI collectively stored in the at least one platformed network 90. As the user interface 68 is provided by the cloud-based vetting system 33, ePHI never remains in memory on the at least one user equipment 10 hosting the user interface 68 to avert compromise of patient privacy or other security concerns.

The frontend module 60 further includes an Application Programming Interface (API) 69. In one exemplary embodiment, the API 69 ensures operability between the user interface 68 and the functional aspects of the cloud-based vetting system 33, such as the SaaS module 40 and the PaaS module 50.

The cloud-based vetting system 33 further includes the web backend module 70. In operation, the web backend module 70 ensures interoperability between the functional aspects provided by the cloud-based vetting system 33 and the at least platformed network 90. For example, in developing their own network systems, each network entity from the plurality of network entities 92 builds on the platform provided by the cloud-based vetting system 33 to facilitate independent user authentication and authorization within government regulatory compliance, such as, among others, HIPAA, HITECH, and other patient information privacy and security regulatory compliance issues, that is updated in real-time. In one exemplary embodiment, the web backend module 70 is based on an HL7 platform.

The web backend module 70 includes an Application Programming Interface (API) 75. The API 75 for ensures, at least in part, interoperability between the cloud-based vetting system 33 and the at least one platformed network 90. As such, the web backend module 70 includes a service delivery portal 76 to ensure continuous operability, through the security firewall 91, between the cloud-based vetting system 33 and the at least one platformed network 90.

As the service delivery 76 portal ensures continuous operability through the security firewall 91, the Synchronization as a Service (SaaS) module 80 ensures that any registration information and ePHI continuously provided by the at least one platformed network 90 in real-time is synchronized with registration information including ePHI provided by users at login with the cloud-based vetting system 33 to ensure that registration information and ePHI, including user identification and authorization information, are maintained at the registry archives 37 is continuously updated. FIG. 4 shows the Synchronization as a Service (SaaS) module 80 including the updater 55 communicatively connected to the registry archives 37 to ensure synchronization of registration information and ePHI to permit real-time authorizations and authentications for each user login session as well entity personnel 98 that rely on the cloud-based vetting system 33 as a Platform as a Service, for example ensuring continuously refreshed information for security purposes.

Operatively, the cloud-based vetting system 33 includes the PaaS module 50. In one embodiment, the PaaS module 50 comprises a Business as a Service (BaaS) function application and, specifically, providing services for independent user authentication and/or authorization within HIPAA, HITECH, and other patient information privacy and security regulatory compliance issues. Furthermore, in one embodiment, the PaaS module 50 comprises an Authorization as a Service (AaaS) function application. In one embodiment, the PaaS module 50 comprises an Authentication as a Service (AaaS) function application.

Referring to FIG. 1, the PaaS module 50 includes an authorization application 52. The authorization application 52 is communicatively connected to the registry archives 37. The authorization application 52 includes a token generator 53 and a token augmentor 54 as shown. Generally, the authorization application 52, based on registration information that includes ePHI, generates a token that corresponds with the user.

Generally, the token generator 53, based on the ePHI and registration information contained in the registry archive 37, creates a token that corresponds to each user registered with the cloud-based vetting system 33. A valid token authenticates and authorizes each specific user at login as that user petitions for access to ePHI maintained on the at least one platformed network 90. The token, in one embodiment, comprises an identifier header for a data packet associated with a particular user registered with the cloud-based vetting system 33. Operatively, the token is provided by the user at login via the authorization application 52 to the at least one platformed network 90 by the web backend module 70.

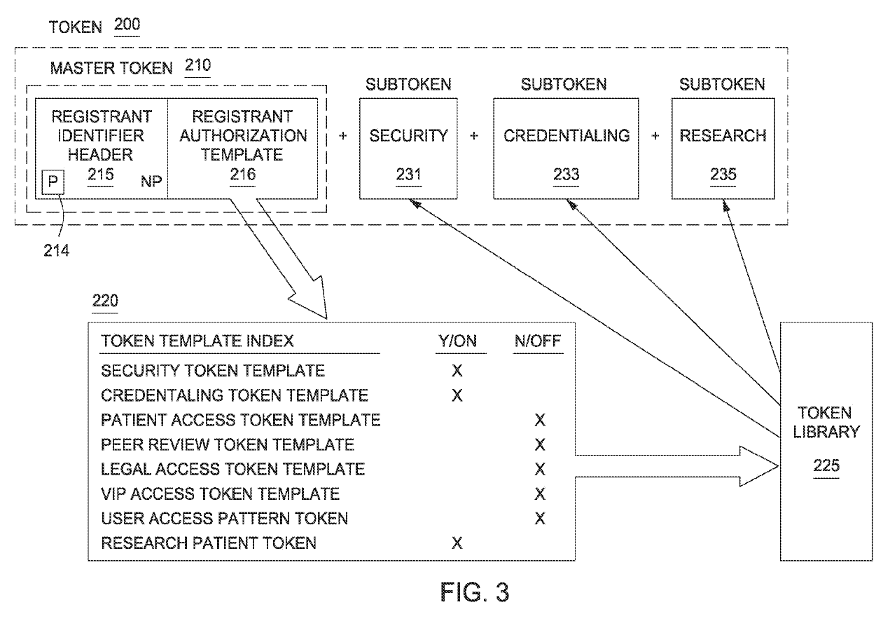

In general, the token generator 53 creates a token. In one embodiment, the token generator 53 creates a token that includes a packet header string having a plurality of authorization switches for activating desired subheaders. The token 200 of FIG. 3, 200 is one exemplary embodiment of a packet header string where the plurality of authorization switches are provided by a template activation matrix 220. Specifically, a registration authorization template 216 includes a template activation matrix 220.

The template activation matrix 220 includes a plurality of authorization switches to construct a packet header string defining the token 200 for each login session. Operatively, in one embodiment, a token facilitates, among others, authorization, authentication, modification, and synchronization operations for each individual user during the login session. Alternatively, those of ordinary skill in the art will readily recognize that a token and subtoken could each be created for continuous use for a plurality of login sessions.

To reduce latency during user login to the cloud based vetting system 33, a token in one embodiment includes at least one template. As such, the token includes a packet header string having a plurality of authorizations switches for activating desired subheaders that are correspondingly associated with subtemplates. Each subtemplate forms the basis for a corresponding subtoken created by the token generator 53 as discussed below. Each subtoken, in operation, authorizes the user for access to ePHI at the at least one platformed network 90. In one embodiment, the authorization application 52, based on the ePHI and registration information, generates at least one subtoken where each subtoken corresponds with an authorization assigned to a specific user for accessing the at least one platformed network 90. Accordingly, in general, the authorization application 52, based on the ePHI and registration information, generates at least one token having at least one authorization assigned to a specific user for accessing the at least one platformed network 90.

During initial registration with the cloud-based vetting system 33, the registration application 42 provides a blank electronic signature HIPAA statement of understanding and acknowledgment forms to the petitioning user so that the user provides information including a signature, electronically, within designated field boxes provided by the form. In particular, the HIPAA acknowledgement form electronically confirms that the petitioning user, as a medical patient, understands their legal rights afforded by HIPAA and HITECH regulations before permitting the user to electronically sign the form.

In one embodiment, a HIPAA release authorization form is another electronic form provided by the registration application 42. The petitioning patient interacts with the HIPAA release authorization form to specify the information, including ePHI information, that can be released; by whom; to whom; in what form or format and for how long. Furthermore, with the HIPAA release authorization form, the patient selects which medical entities and other users with the ePHI-compliant gatekeeper system 1 should receive, in real-time, an active HIPAA release authorization form.

Once electronically signed, the cloud-based vetting system 33 provides the executed HIPAA acknowledgement form to all network entities 92 providing medical care to that patient that is the user of the ePHI-compliant gatekeeper system 1. The registration application 42 provides the executed electronic signature HIPAA authorization and acknowledgment forms to the registry archives 37. The form is stored and updated by the cloud-based vetting system 33 with respect to the user. Each form receives input from the user to render the form legally executable, i.e. legally compliant.

In one embodiment, the HIPAA acknowledgement form and, optionally, the HIPAA release authorization form, are provided to the network entities 92 with a token that is assigned to the user seeking individual medical assistance for a particular login session. In one alternative embodiment, for a continuous connection as opposed to an individual login session, a patient's token provides continuously updated HIPAA acknowledgement forms and, optionally, the HIPAA release authorization forms, to the network entities 92 as facilitated through the service delivery portal 76.

To ensure that an executed electronic signature HIPAA authorization form is relevant to the patient at all times, the updater 55 updates the status of each executed electronic signature HIPAA authorization form in real-time. In general, the electronic signature HIPAA authorization form designates, among others, exactly which medical information will be shared, exactly whom will receive the shared ePHI, the purpose for sharing, an expiration date on which the shared ePHI will no longer be shared with the requestor, and the authorization form must enable a patient who is sharing their ePHI with a requestor to revoke their sharing authorization at any time. Although not presently legally mandated, each network entity from the plurality of network entities 92 also requires that a patient execute an electronic signature HIPAA authorization form for the sharing of that patient's ePHI related information between network entities for purposes of patient care, administrative operations, and billing.

Accordingly, for each subsequent user login to the cloud-based vetting system 33, the token generator 53, in one embodiment, accesses the registry archives 37 to first identify the valid electronic signature HIPAA authorization form and, optionally, release authorization form that corresponds to petitioning user. Furthermore, on location of the form corresponding to the petitioning user, the token generator 53 determines whether the form is updated and valid for the requested login session. Thereafter, the token generator 53 generates a token that includes electronic signature HIPAA authorization and release authorization forms. In one alternative embodiment, the token generator 53 generates a token that includes information that refers to the fact that the requesting user's electronic signature HIPAA authorization form is updated and valid for the requested login session.

Operatively, while using the cloud-based vetting system 33, a patient can issue a HIPAA disclosure release, via an executed electronic signature HIPAA authorization form, that is immediately distributed by the updater 55 to appropriate users of the cloud-based vetting system 33 that are granted disclosure authorization by the patient. The token generator 53 generates a token that authorizes the user to view their corresponding ePHI as this ePHI is also made immediately available to all participating medical entities 92 by the cloud-based vetting system 33. If the patient changes their mind, the permission can be immediately revoked or modified by the updater 55 and token augmentor 54. This changed permission is then distributed through a modification of the online form and the respective authorization assigned to the user's token is modified at the cloud-based vetting system 33.

The token generator 53, in at least one embodiment, creates a token comprising a master token and at least one subtoken. The master token and each subtoken collectively defines the token whereby the token authenticates and authorizes the user, in real-time, to the at least one platformed network 90. For example, a token 200 of FIG. 3 is formed by a combination of a master token 210 and at least one subtoken 231, 233, 235. As shown, the master token 210 includes a registrant identifier header 215 and a registrant authorization template 216. Those of ordinary skill in the art will readily recognize other variations of templates and headers to define a master token.

The token generator 53 creates the registrant identifier header 215 based on ePHI and registration information as the user initially registers with the cloud-based vetting system 33 as obtained by the registration application 42 and stored in the registry archive 37. For the embodiment of FIG. 3, the registrant identifier header 215 includes registration information and ePHI such as the cloud-based vetting system identification code assigned by the cloud-based vetting system 33, password, and biometric scan, and optionally, the users name, a social security number, date of birth, and medical facility ID number.

The cloud-based vetting system identification code provided by the registrant identifier header 215 includes a role key 214. In operation, the role key 214 indicates whether the user of the assigned token is either a medical patient user or a non-medical patient user. If the registrant identifier header 215 identifies the user as a medical patient user such that all information associated with the medical patient user is subject to privacy and security protocols as applied to government regulated health information such as HITECH, HIPAA Privacy and Security Rules. Alternatively, if the registrant identifier header 215 identifies the user as a non-medical patient user such that all information associated with the non-medical patient user is subject to privacy and security protocols of a type well known in the industry, such as privacy and security protocols similar to that of the banking industry. In one embodiment, as indicated by the registrant identifier header 215, the privacy and security protocols applied to medical patient user information are more robust and strict when compared with privacy and security protocols applied to non-medical patient user information.

The authorization application 52, the updater 55, the registry archives 37, and the subscriber application 41 collectively create and maintain the registrant authorization template 216. The registrant authorization template 216 includes a template activation matrix 220.

Generally, the cloud based vetting system 33 provides a token to access the at least one platformed network 90 to initiate an individual login session such that the token collectively validates that the petitioning user has the appropriate, updated authentications and authorizations to access ePHI and other information collectively provided within the at least one platformed network 90. When combined with the master token 210, the authorization application 52 selects each subtoken 231, 233, and 235 that corresponds to the current authorizations permitted to the requesting user for the login session. To ensure access to information within the at least one desired entity, the cloud-based vetting system 33 accordingly presents a token having the master token 210 and the at least one subtoken 231,233,235 to at least one desired entity of the plurality of entities 92. In one embodiment, a subtoken is selected from the group consisting of: a security subtoken, a credentialing subtoken, a patient access subtoken, a peer review subtoken, a legal access subtoken, a VIP access subtoken, a user tracking subtoken, and a research patient subtoken. Those of ordinary skill in the art will readily recognize other subtokens.

Further referring to FIG. 1, the authorization application 52 includes a token augmentor 54. The token augmentor 54 is communicatively connected to the updater 55, the registry archives 37, and the web backend module 70. In operation, the token augmentor 54 modifies any combination of authentications and authorizations provided by the token 200 as initially created by the token generator 53 for each particular user within the ePHI-compliant gatekeeper system 1. Specifically, the updater 55 processes the modifications created by the token augmentor 54 and stores such modifications in the registry archive 37 so as to update the token's authentications and authorizations in real-time. In operation, the updater 55 provides to the registry archives 37, in real-time, the modifications made to the authentications and the authorizations of each token.

The token augmentor 54 modifies access, in real-time, to ePHI related information including a patient's medical file. The token augmentor 54 is communicatively connected to the web frontend module 60 and the web backend module 70. Accordingly, the token augmentor 54 illustratively allows individual patients with their user equipment 10 to modify individual users within the ePHI-compliant gatekeeper system 1 who are authorized to view and change that individual patient's medical information. Moreover, in a further illustration, the token augmentor 54 enables entity personnel 98, such as network administrators, to modify authentications and authorizations for individual patient medical information, such as in direct response network security breach.

Generally, the token augmentor 54 receives a trigger in real-time from the at least one platformed network 90. A trigger initiates the token augmentor 54 to modify the token 200. In particular, the token augmentor 54, based on the trigger, modifies in real-time the master token 210, at least one subtoken 231, 233, 235, or a combination of the master token 210, at least one subtoken 231,233,235. In one embodiment, the trigger comprises the initiating input of a network or IT administrator, as entity personnel 98, to the token augmentor 54. Alternatively, the trigger comprises a predetermined function application, such as among others a predetermined response to any security compromise of ePHI. As such, the updater 55 initially receives the trigger and engages the token augmentor 54 to receive the modifications to a desired token. The token augmentor 54 then provides the modifications to the registry archives 37 for that desired token that is assigned to an individual user, group of users, or entity.

FIG. 3 schematically shows the template activation matrix 220 associating permitted and restricted authorizations currently applied to the corresponding user from all authorizations provided by the registrant authorization template 216. To build the token 200 for the particular login session, the token generator 53 activates only the permitted authorizations provided by the registrant authorization template 216 to create each corresponding subtoken. The token generator 53 combines each subtoken that is applicable to the user with the master token 210 to create the resulting token 200 for the login session.

As shown in FIG. 3, the token generator 53 activates only those templates that correspond to the permitted authorizations to create respective subtokens 231, 233, 235 when combined with the master token 210 to build the token 200. In particular, in one embodiment, registration information and ePHI is constantly updated and maintained in the registry archives 37.

For the embodiment of FIG. 1, the token generator 53 selects the templates from the template library 225 provided within the registry archives 37 that are required for the user while logging-in to the cloud-based vetting system 33. The token generator 53 obtains the updated ePHI and registration information from the registry archives 37 and inserts the ePHI and registration information in the requisite template fields for each selected template to thus activate only those templates that correspond to the permitted authorizations to create respective master tokens and subtokens to build the token for use during that user's individual login session.

For each login session, this process of inserting updated ePHI and registration information in the requisite template fields for each selected template to build a token to access the at least one platformed network 90 via the cloud-based vetting system is repeated. Those of ordinary skill in the art will readily recognize that the token generator 53 can, alternatively, construct a token for use in multiple login sessions such that the token is generated for an initial login session and then store the token in the registry archives 37 after then login session whereby each subsequent login session will then trigger the token generator 53 and the updater 55 to provide updated registration information and ePHI to the stored token thereby activating the token to access the at least one platformed network 90, via the cloud-based vetting system 33.

In one embodiment, each subtoken is generated at least in part from a corresponding template that relates to a particular authorization assigned to the user registrant for that particular login session. As shown in FIG. 3, the token generator 53 creates each subtoken based on the retrieved template corresponding to an activated template index from the registrant authorization template 216. The template activation matrix 220 in FIG. 3 illustratively provides a variety of templates to select from such that each selected template forms the basis for constructing a corresponding subtoken for that particular user registrant during that particular login session. For each activated index provided by the registrant authorization template 216, the token generator 53 accesses the corresponding template in a template library 225 based on the respective activated index. In one embodiment, the template library 225 is provided within the registry archives 37 as shown in FIGS. 1 and 4 and, alternatively, the template library 225 is an independent storage unit, designated for token templates, provided by the cloud-based vetting system 33 as shown in FIG. 5.

For example, among others, the template activation matrix 220 of FIG. 3 includes a plurality of template indices to assist the token generator 53 in retrieving the associated template from the registry archive 37 to create a corresponding subtoken. For the embodiment of FIG. 3, the template activation matrix 220 includes a security subtoken template index, a credentialing subtoken template index, a patient access subtoken template index, a peer review subtoken template index, a legal access subtoken template index, a VIP access subtoken template index, a user tracking subtoken template index, a research patient subtoken template index. Accordingly, as the basis for building a subtoken with the token generator 53, each of these subtoken indexes corresponds to an indexed subtoken template within the template library 225. Alternatively, each of these subtoken indexes corresponds to a previously constructed subtoken template and, optionally, that is integrated with the master token template.

The template library 225 maintains a variety of master token templates and subtoken templates. For example, the template library 225 maintains a variety subtoken templates such as, among others, a security subtoken template as the basis for a security subtoken 231, a credentialing subtoken template as the basis for a credentialing subtoken 233, a patient access subtoken template as the basis for a patient access subtoken, a peer review subtoken template as the basis for a peer review subtoken, a legal access subtoken template as the basis for a legal access subtoken, a VIP access subtoken template as the basis for a VIP access subtoken, a user tracking subtoken template as the basis for a user tracking subtoken, a research subtoken template as the basis for a research subtoken 235. Those of ordinary skill in the art will readily recognize other templates for master tokens and subtokens.

Illustratively, as shown on the template activation matrix 220, the token generator 53 generates the subtoken 231 signifying that a registered user has an active security authorization provided by the employing teaching hospital, the subtoken 233 is created as the user has valid credentialing authorization as a teaching physician, and the subtoken 235 is authorized as the user is permitted to review restricted aspects of patient medical files for purposes of academic research. Accordingly, each subtoken provides an authorization for accessing patient information provided by the at least one platformed network 90.

Accordingly, the generated security subtoken 231 verifies that the registrant user is an active employee of a hospital network from the network entities 92. Optionally, the security subtoken 231 further designates what specific user equipment that the registrant user must login to the cloud-based vetting system 33 such as a login with only medical facility equipment 18 and not medical personnel equipment 19.

Illustratively, the credentialing subtoken 233 verifies that the registrant user is a tenured professor with active credentials to practice as a physician at a teaching hospital of the hospital network. In one embodiment, the credentialing subtoken 233 accounts for, among others, the active medical licensure; active U.S. Drug Enforcement Agency “DEA” license including, among others, active registration; active employment contract; or any other granted privileges to perform medical practice in the illustrated hospital network form the network entities 92. As such, a user discovers that another user's medical license has expired, then the authorization privileges can be immediately revoked at all participating network entities 92, via the updated credentialing subtoken 233.

In one illustration, as relating to a security subtoken 231, a physician user has access to a plurality of enterprises user equipment 17. The security subtoken 231, in part, accounts for the Internet Protocol, IP, addresses of each user equipment 17 assigned to the physician. Moreover, for each enterprise user equipment 17, the security subtoken 231 controls and updates, in real-time, authorizations to access ePHI from the plurality of network entities 92. Accordingly, in the illustration, the security subtoken 231 can be configured such that not all of the physician's enterprise user equipment 17 are authorized to access at least some network entities of the plurality of network entities 92. For example, the security subtoken 231 can restrict the physician from accessing patient ePHI from a mobile device and require only access through a fixed hospital network computer workstation.

In one embodiment, a security subtoken 231 can optionally be configured with a security override function if the user's user equipment 10 incorporates encryption protocols, that are predetermined by the ePHI-compliant gatekeeper system 1. Illustratively, in operation, if a physician user loses user equipment 10 that includes encryption protocols the corresponding security subtoken 231 would not automatically implement security measures typically executed by the ePHI-compliant gatekeeper system 1.

Generally, in operation, each user's security authorizations are governed by with a token 200 maintained on a cloud-based vetting system 33. Accordingly, all user equipment must always first access the cloud-based vetting system 33 to gain access to ePHI collectively maintained at the plurality of network entities 92. For each user, the security subtoken 231 accounts for user authorizations as well as for which user equipment can access the ePHI at the at least one platformed network 90.

Therefore, in at least one embodiment, the security subtoken 231 maintains ePHI access authorizations for both the user as well as for each user equipment. For example, unlike the past where information technology security personnel would rely on a physician's memory regarding what information resided on the physician's missing mobile device and what electronic medical records system was accessed with that laptop, the physician's token 200 maintains ePHI access authorizations for both the physician as well as for the missing mobile device on a cloud-based platform. Therefore, in the event of a security compromise of ePHI due to the missing mobile device, information technology administrators 98, through the security subtoken 231, can readily deny subsequent access with the physician's missing mobile device to the ePHI on the at least one platformed network 90 as well as all other user equipment assigned to the physician to quickly contain the security breach in accordance with government regulations such as HIPAA and HITECH regulations among others. Moreover, to possibly avert costly governmental penalties such as the U.S. HHS's “Wall of Shame” associated with a breach of five hundred or more patient medical files, information technology administrators can further quarantine the breach by suspending ePHI access to include all users associated with the physicians token.

In another illustration, a medical assistant 19 for a doctor's office with login privileges at multiple participating network entities 92 decides to change a career in medicine for working as a teller at a bank. The entity personnel 98, such as the IT administrator for the doctor's office network entity, updates the medical assistant's 19 status at the cloud-based vetting system 33 via the service delivery portal 76 as “terminated employee”. Because the medical assistant is leaving a medical occupation, the cloud-based vetting system 33 updates the “user type” associated with the medical assistant assigned token from medical personnel status to a registered patient for receiving individual health care. In one particular embodiment, collectively with the token augmentor 54 and updater 55, the registrant authorization template 216 of the master token 210 is changed from medical personnel status to a registered individual patent status.

The medical assistant remains an authenticated user with the cloud-based vetting system 33 but the previous medical personnel authorizations are updated to reflect the current status where the former medical assistant can now only view their own personal medical records through the ePHI-compliant gatekeeper system 1. Accordingly, the token augmentor 54 makes the status change to the former medical assistant's token and the synchronizing module 80, in one embodiment, updates the registry archives 37 of the status change, and notifies participating hospital networks and other network entities, each of the plurality of network entities 92, of that change either at the next user login session or as part of a real-time connection with continuous refreshing, such as a during real-time HL7 connection.

In an alternative illustration, as the medical assistant switches between medical practices and not occupations, the medical assistant's token is changed as follows. The user token would be modified to reflect changes in the medical assistant's authorizations so that the medical assistant can no longer access medical records of the patients from the old practice but can access the protected health information of patients including ePHI at the new medical practice. Optionally, token authentications of the medical assistant can change to reflect the new medical practices procedures for employee authentication as executed by the cloud-based vetting system 33. For example, whereas the old medical practice required frequent password updates for authentication, the new medical practice requires the cloud-based vetting system 33 receive both a retinal and voice scan in addition to a password for login authentication. The updater 55, in one embodiment, stores the changes to the token 200 in the registry archives 37. Specifically, in one embodiment, the credentialing subtoken 233 is updated to reflect the medical assistant's new employment status.

Generally, the research subtoken 235 restricts access, at least in part restricts content of patient ePHI, and provides an ad hoc user interface experience. In the continuing illustration, the research subtoken 235 from the cloud-based vetting system 33 indicates to the hospital network from the network entities 92 to provide only medical information relevant to academic research, such as case file images and physicians' reports with personal patient information are removed from the registrant user's view on at least one user equipment 10 during the login session. Only users authorized by the research subtoken 235 can access a restricted subset of the patient's electronic protected health information.

Optionally, to prevent bias, the research subtoken 235 provides command instructions to “blind” or “de-identify” ePHI such that personal identifying information is either removed or blocked from viewing by the researcher. For example, the user interface 68 display for a researcher logged-in to the cloud-based vetting system 33 is altered so the patient's identifying personal information is restricted from view to maintain “blinding”. As such, the researcher is able to access information deemed necessary to the authorized research study.

Illustratively, during initial registration with the cloud-based vetting system 33, a registering patient can, optionally, permit authorizations for voluntary participation in a research study. In one embodiment, the template provided by a research subtoken 235 requires that the user input data into the template's field boxes, displayed on the user interface 68, express authorizations indicating that the patient authorizes a research project investigator to view a designated subset of the patient's ePHI and the patient's “blinding” protocols are also received regarding what specific ePHI will be either removed or blocked from viewing by the researcher. Optionally, the research subtoken 235 will trigger a graphical change displayed on the user interface 68 indicating that the patient is approved for a research study. As a further option, a research subtoken 235 having predetermined “blinding” protocols in strict accordance HIPAA regulations can be applied to any user patient's token without a patient's permission only if such a research study uses “de-identified” ePHI in strict accordance with HIPAA regulations. As a further option, entity personnel 98 can configure the research subtoken 235 to remain in active for the researcher user to access a patient's ePHI for a limited period.

Similar to the research subtoken 235, a user token 200 can combine a master token 210 with a peer review subtoken as used for peer review processes, such as among others for workproduct quality control and a medical peer review that is conducted by committees of physicians toward their peers. For example, the Medicare Improvements for Patients and Providers Act (MIPPA; P.L. 110-275), mandates that radiology imaging studies be subjected to “peer-review” as a means for quality assurance such that the reviewing radiologist is “blinded” from the identity of the reviewed radiologist's work product to remove bias. Operatively, in light of MIPPA, peer review records are subject to the strictest security protocols in the industry and are immune from legal discovery. Accordingly, a peer review token modifies a combination of a reviewer's authentications, authorizations and, optionally ad hoc user interface experience, to establish the required conditions for a “peer-review” under MIPPA.

Illustratively, in a radiology practice, a patient case file is identified for peer review within a radiology “RAD” network of the plurality of network entities 92, as shown in FIG. 1, to ensure quality assurance of workproduct. Entity personnel 98 enter the PaaS module 50 of the cloud-based vetting system 33, at the service delivery portal 76, to assign a peer review subtoken to a user radiologist's master token 210 that will be conducting a quality assurance review of at least one of their peer radiologist's work.

In operation, the user radiologist's token with the peer review subtoken permits the user radiologist to view, in a “blinded” manner at the user interface 68 while on enterprise user equipment 17, a peer radiologist's workproduct relating to a patient case file that is entirely maintained within the radiology “RAD” network of the plurality of network entities 92. The reviewer's experience at user interface 68 is changed by the peer review subtoken so the identity of the radiologist that initially reviewed the study (i.e. “reviewee”) is removed from the report so the reviewer can evaluate the peer reading workproduct without knowing the identity of the radiologist being peer reviewed. Moreover, as a further option, a peer review subtoken having predetermined “blinding” protocols in strict accordance MIPPA regulations can be applied to any user patient's token without a patient's permission in the strict context of a physician peer review only if such peer workproduct uses “de-identified” ePHI in strict accordance with MIPPA regulations.

The patient records associated with the peer workproduct as well as the workproduct itself must be secured as protected peer review material and only accessible by Quality Assurance personnel 98. Thus, in the illustration, the peer workproduct and patient ePHI remains behind the firewall 91 entirely within the radiology “RAD” network of the plurality of network entities 92 while the cloud-based vetting system 33 blinds various aspects of the ePHI for the reviewing user physician while logged-in at the user interface 68 with enterprise user equipment 17.

Similar to the peer review subtoken and the research subtoken 235, a user token 200 can combine a master token 210 with a legal access subtoken as used for purposes of litigation matters such as for discovery in civil and criminal cases. Illustratively, a lawyer with a judicial order requesting access to a patient's medical records is granted access at the cloud-based vetting system 33 via a legal access subtoken. In light of the judicial order, entity personnel 98 enter PaaS module 50 of the cloud-based vetting system 33 at the service delivery portal 76 to assign a legal access subtoken to a lawyer's master token 210 that was received as the lawyer initially registered with the cloud-based vetting system 33.

Depending on the judicial order, the entity personnel 98 configures the legal access subtoken to allow the logged-in user lawyer to view the patient's entire ePHI or to “blind” the patient's medical records so that only a subset of the patient's records is accessed by the lawyer user. The entity personnel 98 will configure the legal access subtoken to remain active for the lawyer user to view the patient's ePHI for a limited period. Illustratively, in operation, the patient ePHI records remain behind the firewall 91 entirely within a hospital network of the plurality of network entities 92 while the cloud-based viewing system 33 blinds various aspects of the ePHI to the lawyer while logged-in at the user interface 68 with user equipment 11.

Generally, a user tracking subtoken and a VIP access subtoken are typically granted to non-patient users of the ePHI-compliant gatekeeper system 1 such as, among others, for network and information technology administrators as well as to select occupational roles such as the security and privacy administrators, marketing personnel, and the chief operating officer of the ePHI-compliant gatekeeper system 1. In operation, each assigned user tracking subtoken accounts for patterns of user activity. The user tracking subtoken collects information regarding, among others, what user equipment are used to access the cloud-based vetting system 33 including device identification numbers and IP addresses, business referral activity of users of the ePHI-compliant gatekeeper system 1, user activity in response to a marketing campaign, and global positioning system, GPS, locations as well as user activity for employment management of personnel. The information collected by the tracking subtoken can be applied in the event where ePHI is compromised and detecting where the breach occurred as well as the extent of the breach.

A very important person, “VIP”, subtoken enables the assigned user to change the authorizations and user interface of other users of the ePHI-compliant gatekeeper system 1. A VIP subtoken assigned user can restrict access to the cloud-based vetting system 33 to only a few users whereas all other past users are provided by the assigned user with a “not-authorized” authorization status. Each user that is assigned a VIP subtoken is permitted to configure another user's token such that the another user's token permits such user to view a patient's entire ePHI or to “blind” the patient's medical records so that only a subset of the patient's records is accessed by such user. Moreover, each user that is assigned a VIP subtoken is permitted to configure another user's user interface 68 display or restrict another user's user equipment from logging-in to the cloud-based vetting system 33.

Optionally, the personal identifying information of each user assigned to a VIP subtoken can be eliminated from all records such that the user is only referred to by an identifying code such as an alphanumeric code randomly assigned by the cloud-based vetting system 33. As a further option, each user must electronically sign a contract prior to assignment of the VIP token so as not to disclose, download, and reproduce any information including ePHI and registration information of all users of the ePHI-compliant gatekeeper system 1.

FIGS. 4 and 5 are each alternative embodiments of the ePHI-compliant gatekeeper system 1. FIGS. 4 and 5 each feature the Synchronization as a Service (SaaS) module 80. As the service delivery portal 76 provides continuous operability between the cloud-based vetting system 33 and the at least one platformed network through the security firewall 91, the Synchronization as a Service (SaaS) module 80 ensures that ePHI continuously provided by the at least one platformed network 90 in real-time is synchronized with registration and ePHI provided by users at login with the cloud-based vetting system 33. In one exemplary embodiment, the service delivery portal 76 comprises a real-time “always-on” HL7 standards connection interface.

Each Synchronization as a Service (SaaS) module 80 includes an updater 55 that is communicatively connected to a registry archives 37. In operation, the updater 55 identifies newly provided ePHI from the at least one platformed network 90 as a candidate for synchronization. Upon confirming that the current ePHI must be updated with the newly provided ePHI, the Synchronization as a Service (SaaS) module 80 includes a synchronization application 81. In general, the synchronization application 81 updates ePHI and registration information in real-time and provides ePHI and registration information to the registry archives 37. The resulting updated ePHI is provided by the updater 55 to the registry archives 37 to ensure that ePHI, including user identification and authorization information, and registration information are maintained at the registry archives 37 is continuously updated.

FIG. 4 shows the Synchronization as a Service (SaaS) module 80 including the updater 55 communicatively connected to the registry archives 37 to ensure synchronization of registration information and ePHI to permit accurate authorizations and authentications in real-time for each user login session as well as for entity personnel 98 that rely on the cloud-based vetting system 33 as a Platform as a Service, for example ensuring continuously refreshed information for security purposes.

In one illustration, entity personnel 98, such as a credentialing officer, at a first hospital network entity 92 discovers that a physician's medical license has been revoked by a medical board and reports this information to an electronic medical records “EMR” system within first hospital network entity's 92 intranet. In one exemplary embodiment, the updater 55 is communicatively connected to the first hospital network entity 92 in real-time through the service delivery portal 76 such that the information reported to the EMR system is also synchronized with the updater 55 provided by the synchronization module 80 of FIG. 4. As such, upon receipt of the change made at the EMR system, the updater 55 triggers the token augmentor 54 to change the physician's corresponding token to reflect the inactive physician medical license first reported at the first hospital network entity's 92 EMR system. Specifically, the updater 55 notifies other network entities, such as a second hospital network entity, an imaging center, and a pharmacy each of the plurality of network entities 92, of the changes to the physician's credentialing subtoken 233 in real time.

FIG. 5 shows the Synchronization as a Service (SaaS) module 80 including an updater 55 and a token augmentor 54, each communicatively connected to one another. The updater 55 and the token augmentor 54 collectively provide updated registration information and ePHI to the registry archives 37 similar to manner described for FIG. 4 above. The registry archives 37 provides updated registration information and ePHI to the token generator 53 and the token augmentor 54 to permit real-time authorizations and authentications for each user login session as well entity personnel 98 that rely on the cloud-based vetting system 33 as a Platform as a Service.

FIG. 5 further includes a template library 225 communicatively connected to the token augmentor 54 of the Synchronization as a Service (SaaS) module 80 and the token generator 53 of the PaaS module 50. Accordingly, in one embodiment, the token generator 53 obtains the updated registration information and ePHI from the registry archives 37 and inserts the registration information and ePHI updated with the Synchronization as a Service (SaaS) module 80 in the requisite template fields for each selected template from the template library 225 to thus activate only those templates that correspond to the permitted authentications and authorizations to create respective master tokens and subtokens to build the token for use during that user's individual login session.

Alternatively, the synchronization application 81, communicatively connected to the subscriber application 41, the authorization application 52, and the registry archives 37, updates registration information and ePHI in real-time and provides registration information and ePHI to the registry archives 37. In one alternative embodiment, the authorization application 52 obtains updated registration information and ePHI from the registry archives 37 and inserts the registration information and ePHI updated by the synchronization application 81 in the requisite template fields for each selected template from the template library 225 to create a token. In one further alternative embodiment, the authorization application 52 obtains updated registration information and ePHI from the registry archives 37 and inserts the registration information and ePHI updated with the synchronization application 81 in the requisite template fields for each selected template from the template library 225 to activate only those templates that correspond to permitted authentications and authorizations to create respective master tokens and subtokens to build the token.

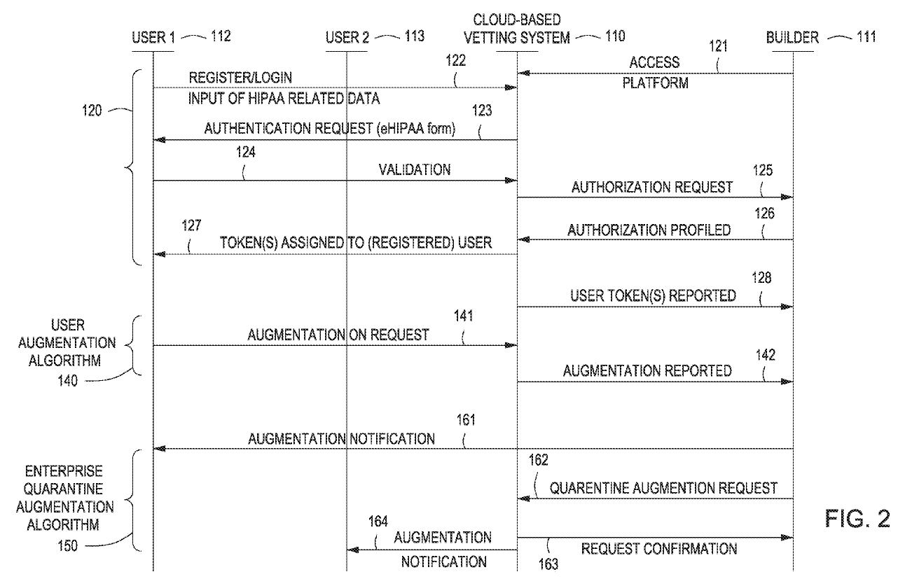

In general, FIG. 2 and FIG. 3 illustrate methods for the ePHI-compliant gatekeeper system 1. Referring now to FIG. 2, methods 100 for operating a ePHI-compliant gatekeeper system 1 includes a cloud-based vetting system 110 may be appreciated. The cloud-based vetting system 110 features at least the same aspects that are discussed above for the cloud-based vetting system 33. FIG. 2 portrays the methods 100 as a sequence diagram that features a plurality of sequence algorithms implemented by the ePHI-compliant gatekeeper system 1 including, among others, a user invitation sequence 120, a user augmentation sequence 140, and a quarantine augmentation sequence 160. In particular, FIG. 2 is a sequence diagram of the ePHI-compliant gatekeeper system 1 showing interactions from the cloud-based vetting system 110, a builder 111, and a plurality of users shown as a first user 112 and a second user 113.

The methods 100 provide a user invitation sequence 120. Generally, the user invitation sequence 120 shows one embodiment of the protocol by which a first user 112, through the cloud-based vetting system 110, petitions to access ePHI related data from a builder 111, such as a platformed entity 92.

Through a received PaaS plugin 48, the builder 111 includes the platformed services provided by the cloud-based vetting system 110 as a component of builder's 111 network infrastructure and thus, in step 121, accesses the cloud-based vetting system 33 at the service delivery portal 76.

The first user 112 in step 122 provides registration information and ePHI input to the cloud-based vetting system 110 while either registering or logging-in to access information from at least one builder 111. In step 123, the cloud-based vetting system 110 provides an authentication request to the first user 112, such as a blank electronic signature HIPAA authorization form for esignature or, optionally, a request for a bioscan. In step 124, the first user 112 provides data to the cloud-based vetting system 33, such as among others an esignature or a bioscan, thereby validating the first user 112.

Upon authenticating the first user 112, the cloud-based vetting system 110 in step 125 inquires what authorizations the builder 111 will provide to the first user 112 during the requested login session, such as whether to permit the user to view names and social security numbers of patients. In step 125, the updater 55 petitions the platformed entity 92 for desired first user access 112 to provide any updates to the corresponding user token stored in the registry archives 37.

In step 126, the builder 111 provides the authorization profile for the first user 112 during the requested login session. For example, a radiology network platformed entity 92, as the builder 111, provides authorization profiles to the cloud-based vetting system 33 authorizing a referring physician, the first user 112, to view the imaging and a radiologists report on a new patient.

In step 127, in response to the authorizations received by the builder 111, the cloud-based vetting system 110 generates a token to be assigned to the registered first user 112 for the duration of the login session. Alternatively, in step 127, in response to the authorizations received by the builder 111, the cloud-based vetting system 110 retrieves a token assigned to the registered first user 112 from the registry archives 37 for the duration of the login session.

In the continuing example, the referring physicians token or header string includes a subtoken granting authorization for viewing medical records based on new patient access provided by the radiology network platformed entity 92.

In step 128, the cloud-based vetting system 110 optionally reports the user subtoken assignment to the builder 111 regarding the authorization of the referring physician to access the new patient's files at the radiologist network for the requested login session.

The methods 100 further provide a user augmentation sequence 140. Specifically, in step 141, the first user 112 makes a request to the cloud-based vetting system 110 to change access privileges carried by the first user's 112 assigned token. In step 142, the cloud-based vetting system 110 reports to the builder 111 that the first user 112 is requesting token modification.

Illustratively, in step 141 the first user 112 as a multiple myeloma patient restricts a past physician from continuing to access their ePHI related information through the cloud-based vetting system 110. In step 142, the cloud-based vetting system 110 then reports the physician restriction to hospital network platformed entity 92 as provided by the at least one platform network 90.

The methods 100 also provide a quarantine augmentation sequence 160. In step 161, the builder 111 notifies the first user 112 of either an unauthorized change or breach of the first user's 112 ePHI related information within the builder's 111 specific internal network entity of the plurality of network entities 92. Then, in step 162, the builder 111 provides a quarantine augmentation request 162 to the cloud-based vetting system 110. Such notification in step 161 is either automatic or, alternatively, provided and updated in real-time by entity personnel 98, such as a network administrator, at the service delivery portal, such as through an HL7 data pipe.

The cloud-based vetting system 110 in step 163 confirms the quarantine augmentation request to the builder 111. Accordingly, in step 164, the cloud-based vetting system 110 provides notification to a second user 113 of a breach to the first user 112 and changes both the first and second users 112, 113 authorization privileges within their respective tokens to contain or “quarantine” the security breach to those who have been directly associated with the first user 112's master token.

Based on a quarantine trigger, the authorization application 52 restricts authorizations of users associated with the quarantined master token of the compromised first user 112. In one exemplary embodiment, the authorization application 52 based on a quarantine trigger restricts authorization of users associated with a quarantine subtoken of the compromised first user 112.

A method for authentication is appreciated as follows. A communication link is established between user equipment 10 and an authentication application 43 of a cloud-based vetting system 33. With a subscriber application 41 provided by the cloud-based vetting system 33, registration information that includes electronic protected health information “ePHI” is received from at least one user equipment 10. A corresponding token is generated based on the registration information and ePHI with a token generator 53 provided by the cloud-based vetting system 33. In response to a trigger, the token is changed in real-time.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The terms “coupled” and “linked” as used herein is defined as connected, although not necessarily directly and not necessarily mechanically. A device or structure that is “configured” in a certain way is configured in at least that way, but may also be configured in ways that are not listed. Also, the sequence of steps in a flow diagram or elements in the claims, even when preceded by a letter does not imply or require that sequence.

What is claimed is:

1. An ePHI-complainant gatekeeper system for governing user access comprising:
user equipment;
a cloud-based vetting system communicatively connected to the user equipment, the cloud-based vetting system includes a subscriber application, an authorization application, a synchronization as a service module, and a registry archive;
the subscriber application communicatively connected to the user equipment, the subscriber application receiving registration information that includes ePHI from the user via the user equipment;
the subscriber application includes an authentication application, the authentication application communicatively connected to at least one platformed network and the registry archive;
a token corresponding to a user generated by the authorization application, the token generated based on the registration information that includes ePHI;
the synchronization as a service module communicatively connected to the at least one platformed network, the subscriber application, the authorization application, and the registry archive;
wherein the synchronization as a service module synchronizes ePHI continuously provided by the at least one platformed network in real-time with registration information provided by the user at login with the cloud-based vetting system.

2. The ePHI-compliant gatekeeper system according to claim 1 wherein the token includes an identifier header.

3. The ePHI-compliant gatekeeper system according to claim 1 wherein the header includes a cloud-based vetting system identification code.

4. The ePHI-compliant gatekeeper system according to claim 2 wherein the cloud-based vetting system identification code includes a role key.

5. The ePHI-compliant gatekeeper system according to claim 3 wherein the role key indicates whether the user of the assigned token is a medical patient user.

6. The ePHI-compliant gatekeeper system according to claim 3 wherein the role key indicates whether the user of the assigned token is a non-medical patient use.

7. The ePHI-complaint gatekeeper system according to claim 1 wherein the authorization application, based on a quarantine trigger, restricts authorization of users associated with a quarantined token of the comprised user.

8. An ePHI-compliant gatekeeper system for governing user access comprising:
user equipment having a unique identifier;
a cloud-based vetting system communicatively connected to the user equipment, the cloud-based vetting system includes an authorization application, a synchronization application, and a registry archive communicatively connected to the authorization application and synchronization application;
the authorization application communicatively connected to at least one platformed network and communicatively connected to the registry archive;
a token generated by the authorization application based on registration information associated with a user;
the token including information to grant the user to access the at least one platformed network, wherein the token authorizes the user to access the at least one platformed network; and
wherein the synchronization application updates the user's authorizations in real-time with respect to the token for each login session.

9. The ePHI-compliant gatekeeper system according to claim 8 wherein the token determines the specific user equipment the user can access ePHI the at least one platformed network with the cloud-based vetting system.

10. The ePHI-compliant gatekeeper system according to claim 8 wherein the token blinds the ePHI personal identifying information from access by the user.

11. The ePHI-compliant gatekeeper system according to claim 8 wherein the token includes a master token.

12. The ePHI-compliant gatekeeper system according to claim 8 wherein the token includes a subtoken.

13. The ePHI-compliant gatekeeper system according to claim 8 wherein the token includes a template.

14. The ePHI-compliant gatekeeper system according to claim 12 wherein the master token includes a registrant authorization template, the registrant authorization template includes a token template index.

15. The ePHI-compliant gatekeeper system according to claim 12 wherein the subtoken is selected from the group consisting of: a security subtoken, a credentialing subtoken, a patient access subtoken, a peer review subtoken, a legal access subtoken, a VIP access subtoken, a user tracking subtoken, and a research patient subtoken.

16. The ePHI-compliant gatekeeper system according to claim 8 wherein the authorization application further includes a token augmentor, and wherein the token augmentor, initiated by a trigger, modifies the token.

17. The ePHI-compliant gatekeeper system according to claim 16 further comprises an updater, the updater is communicatively connected to the token augmentor, the registry archives, and the web backend module, and wherein the updater provides to the registry archives in real-time the modifications made to the authentications and the authorizations of each token.

18. The ePHI-compliant gatekeeper system according to claim 8 wherein the authorization application, based on a quarantine trigger, restricts authorization of users associated with a quarantined token of the comprised user.
